(19) United States
(12) Patent Application Publication
(10) Pub. No.: US 2021/0080242 A1
(43) Pub. Date: Mar. 18, 2021

(54) METHOD AND SYSTEM FOR MEASURING DEFORMATION OF A SURFACE

(71) Applicant: PAVEMENT ANALYTICS LIMITED, South Dunedin (NZ)

(72) Inventor: Graham Alexander SALT, South Dunedin (NZ)

(73) Assignee: PAVEMENT ANALYTICS LIMITED, South Dunedin (NZ)

(21) Appl. No.: 17/106,475

(22) Filed: Nov. 30, 2020

Related U.S. Application Data
(63) Continuation-in-part of application No. PCT/NZ2019/050058, filed on May 29, 2019.
Application No. PCT/NZ2019/050058 is a continuation-in-part of application No. 15/781,219, filed on Jun. 4, 2018.

(30) Foreign Application Priority Data
Dec. 4, 2015 (NZ) 714896
May 18, 2016 (NZ) 720276
May 30, 2018 (NZ) 743043

(51) Int. Cl. G01B 5/30; G01P 15/18; G01P 15/08; G01C 19/00

(52) U.S. Cl. CPC G01B 5/30; G01C 19/00; G01P 15/08; G01P 15/18

(57) ABSTRACT

Deformation of a surface, such as a pavement surface is measured using a rolling weight or wheel carrying one or more gyroscopes positioned to measure the deformation occurring at a point on or near the perimeter of the wheel. The weight is rolled over the surface to be measured. The signals developed by the one or more gyroscopes during a stationary cycloidal period of the point on the perimeter of the wheel are analysed to provide a measure of surface deformation based on the one or more signals.

### RELATED APPLICATIONS

This application is a Continuation-in-Part of PCT/NZ2019/050058, filed 29 May 2019, which claims benefit of Serial No. 743043, filed 30 May 2018 in New Zealand, and which applications are incorporated herein by reference.

This application is also a Continuation-in-Part of U.S. application Ser. No. 15/781,219, filed 4 Jun. 2018, which is a National Stage of PCT/NZ2016/050191, filed 2 Dec. 2016, which claims benefit of Serial No. 714896, filed 4 Dec. 2015 and Serial No. 720276, filed 18 May 2016, and which applications are incorporated herein by reference. For convenience U.S. patent application Ser. No. 15/781,219 is appended to the current specification as Appendix A.

To the extent appropriate, a claim of priority is made to each of the above disclosed applications.

### FIELD OF INVENTION

The present invention relates to determination of one or more structural parameters of a surface.

### BACKGROUND TO THE INVENTION

Load bearing capability is a fundamental property that requires quantification for all types of pavement structures. This encompasses roads (both local and state highways), airport runways, heavy duty pavements and in many earthfills and hardfills where adequate compaction and strength are important. Pavement structural capacity may deteriorate, over time, owing to a number of factors, including changes in the elastic moduli of sub-pavement layers of bound layers, aggregates or earth. In order to determine pavement condition, the load bearing capability of the pavement can be periodically tested to quantify its structural condition. It is desirable to utilise technologies that are non-destructive so that the integrity of the pavement surface is maintained. Further, the measurements should desirably be made rapidly or at least at customary traffic speed, through an automated system, to minimize time, avoid impediments or risk to road users and reduce costs.

Deflectometers measure the deflection of a surface (such as a road or pavement) under a given force and use this deflection either to calculate some strength or stiffness parameter (e.g. the elasticity modulus) or to use the deflection as a direct empirical measure of the strength and stiffness.

Different methods have been developed for the non-destructive testing of pavements, with one utilizing a falling weight dropped on a plate on the pavement from a stationary platform. A row of stationary geophones (velocity sensors) placed on the road and extending horizontally in the direction of travel from the centre of the load plate then measure the deflection of the pavement at intervals out from the falling weight. Systems utilizing this method are commonly referred to as falling weight deflectometers (FWD or FWDs). Measurement is performed when the testing equipment is stopped, ie no movement in the direction of vehicle travel. As this is a static test it is very slow when acquiring a number of measurements.

In the 1950s the Benkelman Beam, with manual measurement of deflection allowed up to 300 measurements per day with a skilled crew.

The Lacroix and California Traveling Deflectograph were based on the Benkleman Beam and utilise probes placed on the road surface to measure the deflection from a constantly moving lorry. These devices are limited to a maximum speed of about 7 kmph.

The French Curvia\grave{m}etre utilises Geophones mounted on a continuous closed-loop track passing between two wheels (i.e. the wheels do not drive on the chain) with the chain travelling on the pavement surface between dual rear wheels. Measurements are taken when the chain approaches and passes between the two rear wheels. The fifteen meters long closed-loop chain is equipped with three geophones generating a result every five meters. This design was limited to a top speed of about 20 kmph. With this device the track passes in the space between dual wheels, not beneath a loaded tyre, nor does this device test at highway speed.

Other slow speed devices are used during compaction of soil or granular layers and use the vibration frequencies of a steel wheeled compactor to measure the change in stiffness and degree of compaction, during the compaction process. The vibration frequencies and amplitude in relation to the roller forward movement speed are examined and used to optimise the compaction process and are not applied to structural analysis of pavement life.

Due to the speed limitations of these devices laser based systems were developed.

TSD or Traffic Speed Deflectometer, traditionally using laser velocity measurement from a horizontal beam on the test vehicle, measures pavement vertical velocity with a row of sensors extending horizontally in the direction of travel from the centre of loaded dual wheels. It is carried out while the testing equipment is intended to be travelling at traffic speed, but in practice is often limited to 70 kmph because trucks tend to set up vibrations so the signal to noise ratio deteriorates at higher speeds, usually limited to well below 100 kmph.

RWD or Rolling Weight Deflectometer, traditionally using laser distance measurement from a horizontal beam on test vehicle, to measure pavement deflection between loaded dual wheels with a row of sensors extending horizontally in the direction of travel. It is intended to be carried out while the testing equipment is travelling at traffic speed.

The Purdue Deflectograph includes at least four non-contact laser range finders mounted in a line along the vehicle. A geometric relationship is then used to calculate the deflection. High Speed Deflectographs use laser Doppler velocity-meters rather than the “standard” laser triangulation distance-meters. These devices are, however, complex and capital cost is expensive.

The TSD and RWD systems utilise a fast moving, heavy dual wheel load that rolls along the pavement, with sensors being arranged at intervals out from between the centre of the dual wheels to measure deflection. A device of this type is disclosed in U.S. Pat. No. 4,571,695. In essence, a load is placed on a dual wheel assembly that rolls along the pavement and the depth of a deflection basin created by the loaded dual wheels is measured using precision laser sensors mounted on a horizontal member that tracks with the dual wheel. Such deflection measurements provide insight into the load bearing capability of the pavement. However, pavement deflections are usually very small, typically 0.010 to 0.100 inch for a 20,000 pound applied axle load. Therefore, not only are extremely sensitive sensors required to measure the deflection, but the sensors should have a stable reference plane.

Correlations and/or use of elastic theory are also required because pavement acceleration (or velocity or deflection) alone provides limited information regarding the bearing capacity of a pavement. In the mechanistic-empirical method of pavement design, the permissible number of load applications, to cause a certain level of damage to the pavement structure, is determined from the critical stresses or strains in the pavement layers. The rates at which rutting or roughness of a pavement progresses are normally related to the vertical compressive strain at the top of the subgrade, and cracking to the horizontal tensile strain at the bottom of a cement- or bitumen-bound layer.

Worldwide, traffic speed deflectometer data is being collected but from the literature and enquiry it appears that all organisation use only empirical parameters for interpretation. Some are averaging the readings over many metres so the singular characteristics are replaced with averages that do not reflect the relevant nature of the pavement, which is inherently variable.

The applicant's prior international patent application PCT/NZ2016/050191, the disclosure of which is hereby incorporated by reference, discloses a method and system for measuring the deformation of a surface using one or more accelerometer or one or more IMU (including an accelerometer and a gyroscope). Whilst a method employing an accelerometer is very effective it becomes increasingly subject to the effects of noise (as found with all other forms of deflection measuring equipment) at higher speeds, particularly speeds above 70 kmph. The applicant has discovered that using only a gyroscope, without an accelerometer, that the signal produced by a gyroscope at speeds over 70 kmph is in fact surprisingly noise free and enables superior measurement of deformation at higher speeds. Trials have shown that the gyroscope signal is still unaffected to at least 90 km/hr and it is therefore reasonable to expect this technique could be used globally even on roads with speed limits over 100 km/hr, ie high speed motorways, without imposing the slightest inconvenience to any other road users nor any added risk to road safety. This is surprising as established thinking in the field was that due to the need for double integration that the resulting drift would make gyroscopes unsuitable for this application. No other pavement deflection measurement system does this. Signal processing of signals from a gyroscope is also easier than signals from an accelerometer because of the higher signal to noise ratios.

### SUMMARY OF THE INVENTION

After several years of experiment it was discovered that the output of an accelerometer positioned so that it measures the deformation of a point located on or near the wheel perimeter at cycloid stationary periods (i.e. when the point to be measured is pressed against the pavement surface beneath a loaded wheel at the point of maximum deformation) has low noise at moderate speeds and when appropriately positioned, provides an accurate correlation with pavement structural parameters including the maximum vertical deflection of the surface. Accuracy diminishes at very high speeds, but useful information is still recorded well over the maximum speed limit for the TSD operation. The Applicant's arrangement may be referred to as a Dynamic Screening Deflectometer (DSD).

Upon further experimentation the Applicant has surprisingly discovered that a gyroscope alone may provide useful information to determine surface deformation and can in fact provide superior results to an accelerometer alone, particularly at speeds above about 70 kmph. Gyroscopes alone have never been used for pavement analysis as the expectation was that drift resulting from the required double integration and noise would overcome any useful signals. In fact, surprisingly, it has been discovered that a less noisy signal is actually produced by a gyroscope at speeds over about 70 kmph than from an accelerometer because of the particular nature of truck vibration on a road coupled with the way the sensor is impressed onto a surface over the cycloid stationary period, such that it is largely insensitive to the prevailing waves that are set up by a moving vehicle.

The gyroscope as used in the DSD has an important difference in that it is the only device that can directly measure rotational velocity at the centrepoint of the tyre load and can therefore enable a direct measure of curvature of the surface at the point of maximum curvature which enables the properties of the layer closest to the surface to evaluated. Other devices focus on the point between dual wheels which has lesser curvature than under the loaded wheel, and is less sensitive to the properties of the pavement forming and immediately beneath the surface.

The gyroscope signal may be integrated with respect to time to determine additional parameters including in particular the curvature of the pavement deflection bowl at the point of application of the rolling load (i.e. angular displacement). The advantage now is the compact size and low cost of sensors. Gyroscopes are also available in a composite form (inertial measurement unit or IMU), most with capacity to measure magnetic orientation and acceleration. Note, because the majority of the useable information for the intended purpose is rotation, the terms gyroscope and rotational velocity are used below, but they are used herein to denote each of the characteristics detected by one or more gyroscopes, accelerometers or IMUs (or calculated from their measurements) and including one or more relevant parameters, being acceleration, linear velocity, angular velocity, jolt and magnetic orientation, about any or all three dimensions, measured individually, with reference to either a single or multiple axes, or in any combination, in the situations and for the purpose described below.

The present invention relates to determination of one or more structural parameters of a surface, particularly, although not exclusively, the invention relates to non-destructive testing of pavements and in particular to methods and apparatus for determination of pavement structural parameters including e.g. one or more of deflection, curvature and stiffness of pavements as well as direct correlations with distress severity. The testing can be carried out at either fast or slow speeds using one or more rolling weights or wheel(s).

The same concept used for measurement at high speed, can also be used at slow speed. During the trials for the gyro within a rolling wheel, inspection of the gyro signatures have revealed an additional purpose and a methodology that has now been developed. The methodology, for the first time overcomes the limitations in the LNEC trials in the 1990's, that is: to use one or more gyroscopes or IMU's with one or more axes in a stationary setting placed in close contact on, or in the surface a short distance away from the loaded wheel followed by a new methodology for relating the gyro measurements to structural propertries including one or more of rate of rotation, deflection, curvature, or layer moduli. This particular methodology when used in earthworks construction enables construction quality control of earthworks much more quickly and cheaply than any existing method.

According to a first aspect there is provided a method of measuring deformation or structural properties of a surface comprising:
a. providing a gyroscope positioned to measure deformation at or near the periphery of a rolling weight;
b. rolling the rolling weight over the surface;
c. analysing one or more signals developed by the gyroscope during a stationary cycloidal period of the gyroscope; and
d. developing a measure of surface deformation or structural properties based on the one or more signals.

According to a further aspect there is provided a system for measuring the deformation or stuctural properties of a surface including:
a. a rolling weight;
b. a gyroscope or gyroscopes positioned on or near the rolling weight to measure deformation at or near the periphery of the rolling weight; and
c. a signal analysis circuit which:
   i. receives signals from the gyroscope;
   ii. analyses the signals to identify stationary or stationary cycloid periods of the gyroscope;
   iii. extracts rotational information for the identified stationary periods; and
   iv. develops one or more measures of surface deformation or structural properties based on the extracted gyroscope information.

According to a further aspect there is provided a system for measuring the deformation or structural properties of a surface including:
a. a rolling weight;
b. a gyroscope positioned on or near the rolling weight to measure deformation at or near the periphery of the rolling weight; and
c. a signal analysis circuit which:
   i. receives signals from the gyroscope;
   ii. identifies stationary or stationary cycloid periods based on user input;
   iii. extracts rotational information for the identified stationary periods; and
   iv. develops one or more measure of surface deformation or structural properties based on the extracted rotational information.

The gyroscope may be positioned on or near the periphery of the rolling weight, on or near the periphery of a wheel near the rolling weight or be mounted in or to the surface.

Whilst the “surface” will typically be a pavement surface the method and system may be applied to other surfaces, such as one or more tracks of a railway line. In the case of a railway line the railway wheel is replaced with a rebated compressible wheel to maintain position on the rails as well as give a reasonable duration for the cycloidal stationary period.

According to a further aspect there is provided a system for measuring the deformation or structural properties of a surface including:
a. a gyroscope positioned to measure deformation proximate to the surface for direct force transmission from the surface;
b. a rolling weight for applying a downward force to the surface; and
c. a signal analysis circuit which:
   i. receives signals from the gyroscope;
   ii. analyses signals during periods of application of downward force; and
   iii. develops one or more measure of surface deformation or surface structural propertiess based on the extracted rotational information.

According to a further aspect there is provided a tyre belt or mesh adapted to fit to the tyre of a vehicle for measuring the deformation of a surface comprising a belt adapted to be fitted about a vehicle tyre having one or more gyroscope sensors positioned to measure deformation at or near the periphery of the belt.

Where reference is made above to a gyroscope it will be appreciated that this is inclusive and encompasses for example multiple gyroscopes and IMUs incorporating one or more gyroscope.

According to a further aspect there is provided a tyre for measuring the deformation of a surface including one or more gyroscopes positioned to measure deformation at or near the periphery of the tyre.

According to a further aspect there is provided a method of determining water content of material underlying a surface by measuring deformation of the surface at or near a rolling weight and determining water content of the underlying material based on the relative smoothness of the shape of the response curve compared with a reference curve of a surface having known water content.

### BRIEF DESCRIPTION OF THE DRAWINGS

The invention will now be described by way of example with reference to the accompanying drawings in which:

FIGS. 1A to 1C illustrate a trajectory defined by a device mounted at or near the periphery of a rolling wheel;

FIG. 2 shows a rolling weight having a plurality of gyroscopes distributed about its periphery;

FIG. 2A shows a track driven arrangement in which a plurality of gyroscopes are provided along a track driven around two wheels;

FIG. 3 shows a gyroscope mounted within a mesh secured to a wheel;

FIG. 4 shows a gyroscope embedded within the tread of a wheel;

FIG. 5 shows a schematic diagram of a system for measuring the deformation of a surface;

FIG. 6 shows a sample recording from a gyroscope embedded in a wheel;

FIG. 7 shows a high speed event;

FIGS. 8A to 8C show methods for communication of data between the sensor(s) and a computer;

FIG. 9 is a flow chart illustrating one embodiment of measurement method;

FIG. 10 shows a plot of rotational velocity versus time;

FIG. 11 shows a gyroscope forward rotation axis when the rotational velocity is measured from an adjacent wheel or from a point on the surface within the deflection bowl;

FIG. 12 shows a gyroscope lateral rotation axis when the rotational velocity is measured from an adjacent wheel or from a point on the surface within the deflection bowl;

FIG. 13 shows an example image of a test result displayed on a smart phone;

FIG. 14 shows example bowl deflection data;

FIG. 15 illustrates the fitting of curve fitting solutions to displacement data using Excel; and

FIG. 16 shows a range of possible valid bowl profile solutions.

### DETAILED DESCRIPTION OF PREFERRED EMBODIMENTS

In one aspect the present invention involves positioning one or more gyroscopes at or near the perimeter of a heavily loaded rolling wheel and/or nearby rolling wheels to make possible the utilisation of the stationary period in cycloid movement when the rugged sensor housing of a gyroscope becomes pressed against the road surface. The sensor may measure and record the rotation velocity versus time history of motion from which pavement curvature and/or the “signature” shape of part of the record is used to determine pavement structural properties for asset management, design or construction quality assurance. The sensor may alternatively be located in or on the surface within the bowl of surface deformation, or in a wheel some distance in from the perimeter of the wheel but rigidly connected in a manner that it will record the deformation of the perimeter. For example, the gyroscope may be mounted with a rigid connection to the measuring pad which is pressed against (typically mounted to) the road. The gyroscope needs to be positioned within the bowl of deflection influence, which in a typical pavement situation may be about 1.5 to 2 metres from the rolling weight.

This information may then then utilised to determine more than rotational velocity and according to the present invention may be utilised to determine curvature of the pavement surface as well as critical strain parameters or structural parameters that can be applied to predict bearing capacity, deformation, potential for cracking, rutting progression, roughness progression, remaining life, rehabilitation requirements and associated characteristics of pavements. This approach enhances the value of pavement testing while at the same time allowing for testing systems having both slow, medium or fast moving wheel loads. The collected data from multiple wheels of different configurations can be used to determine pavement life, vertical compressive strain, shear strain and horizontal tensile strain and other structural properties, which can be more valuable for the prediction of remaining pavement life and design recommendations for repair and maintenance.

Instead of a simple gyroscope, one or more inertial measurement units (IMUs) may be employed. An IMU is an electronic device that measures and reports a body's specific acceleration/force, angular velocity rate, and sometimes the magnetic field surrounding the body, using a combination of accelerometers and gyroscopes, and sometimes also magnetometers. IMUs often contain three accelerometers and three gyroscopes and optionally three magnetometers. The accelerometers are commonly placed such that their three measuring axes are orthogonal to each other. They measure inertial acceleration, also known as G-forces. Three gyroscopes may be placed in a similar orthogonal arrangement, measuring rate of rotation in reference to an arbitrarily chosen coordinate system. Three magnetometers may also be included to allow better performance for dynamic orientation calculation.

Where an IMU is employed multiple characteristics of the sensors may be used to quantify desired parameters and address instrument noise and drift. As well as rotation, acceleration and velocity may be used to determine the change in deflection over the stationary period, in particular, the curvature of the deformed shape of the pavement deflection bowl at the point of greatest curvature, which in itself is a widely used empirical parameter for design of asphaltic pavements. Detecting the earth's magnetic field may be used for orientation, including identification of any localised deviation of the vehicle path from a straight line so that anomalous readings that occur simultaneously can be corrected in the quality assurance process.

A horizontal pressure wave due to forward motion of the wheel as the wheel approaches a surface, followed by its reversal as it goes away from it, is a deformation characteristic that the invention may utilise, either in conjunction with or independent from, readings from other sensors on the heavily loaded wheel or nearby wheels, to determine the stiffness properties of the pavement, which are then used for remaining life and rehabilitation requirements.

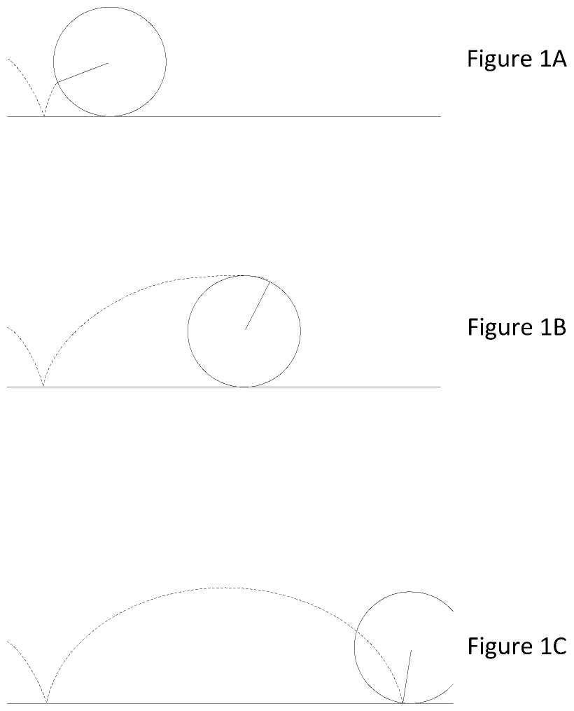

Intuitively many would expect the perimeter of a rolling wheel would be subject to very large rotations and accelerations from centrifugal forces, so any small movement of the pavement itself would be indistinguishable and attempts to construct a device that would be practical, would be futile. This is not the case, as explained below with reference to FIGS. 1A to 1C.

The dashed trajectory defines the locus of the gyroscope position on the perimeter of the wheel and the cusp that meets the solid line (road surface) defines the stationary period of the sensor, when it has zero horizontal velocity, irrespective of the velocity of the centre of the wheel (assuming the pavement is rigid). Because all road surfaces and wheels are not infinitely stiff, the compression of either will extend the stationary period from instantaneous to several milliseconds or longer and this duration can be controlled with wheel materials (or tyre pressures). By using high frequency (sub-millisecond) sampling of sensors many times during the stationary period, correlation of those rotational velocities with the state of trafficked pavements, measured deflections, curvatures or velocities under traditional devices (such as Beam, Deflectograph, FWD RWD or TSD) enables rapid and reliable assessment of pavement structural capacity.

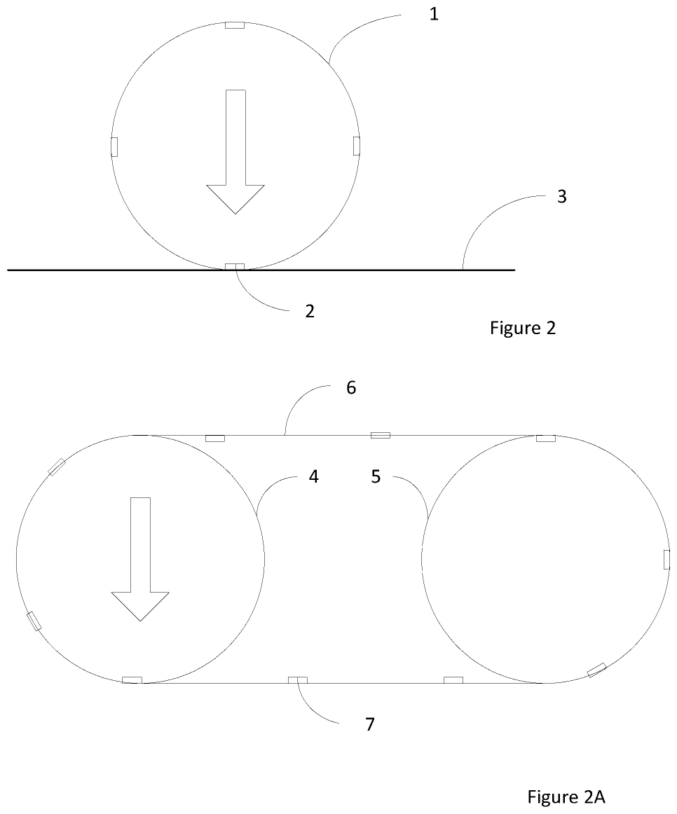

Referring to FIG. 2 a rolling weight in the form of a wheel 1 has four gyroscopes 2 housed in ruggedised housings positioned about (at or near) its periphery. It will be appreciated that where a gyroscope is described below that an IMU or other ancillary sensors may be substituted. In this example the gyroscope housings are embedded within the tyre tread so that the ruggedised housings are substantially flush with the surface of the tyre tread, although they could be located anywhere at or near the tyre surface as long as adequate data could be obtained for the type of wheel used, the type of surface and the information required. Whilst four gyroscopes 2 are shown any number may be provided depending upon the measurement interval required and number of nearby wheels to widen the definition of the deformation away from the loaded wheel. An alternative configuration may be to have the loaded wheel(s) not instrumented, with all measurements taken only from a nearby wheel(s) which has only nominal loading but using the same principle.

While the gyroscopes may be used alone, the stationary cycloid interval also allows enhanced analysis because pavement surface texture can also be measured using the same principle, measuring the degree of sealing achieved, when a fluid is injected centrally to the footprint of a tyre, as explained below. Correction of results for the “seating effects” of texture increases the accuracy of the structural parameters determined but also allows a new method of determining estimates of texture and hence skid resistance, which are traditional parameters collected with other high-speed vehicles which measure pavement surface properties. However, adopting the stationary cycloid principle allows substantial cost savings by collecting all properties with a single vehicle, and if air is used (after appropriate calibration) rather than water (as traditionally used for skid resistance measurement) there are further savings in the operational time and logistics through avoidance of stops for water re-filling of the traditional tankers. Other ancillary sensors commonly associated with an IMU may record temperature and strain.

It will be appreciated that a strain gauge coupled to an inertial mass could form a gyroscope. A strain gauge housing pressed against the surface or used with an inertial mass could indirectly be used to approximate the more primary measurement of curvature made by the gyroscope. For this reason, the focus of this application is the measurement of pavement surface curvature at traffic speed from a device located on or in proximity to the perimeter of a rolling wheel using the stationary cycloidal period for the purposes of evaluating engineering properties of the pavement (not properties of the tyre or wheel). No other device derives such a direct measure of pavement curvature at traffic speed (i.e. typically 20 to 90 km/hr). They deduce curvature indirectly from sensors that take discrete readings of vertical deformation at specific points along the deflection bowl.

To include measurement of pavement surface texture and hence skid resistance, air (or other fluid) can be continuously supplied under pressure (readily achieved using the established central tyre inflation system) to the tyre. A fine tube allows a limited flow of fluid to escape from the pressurising system through an appropriately small hole to a disc shaped cavity recessed into about the middle third of the tyre tread. Just beyond the cavity the usual tyre grooves are filled to provide an annulus of smooth rubber, flush with the tread, to promote a partial seal when in contact with the pavement during the stationary cycloidal interval. The escaping fluid may be instrumented with a rapid response pressure sensor thus providing a measure of the effectiveness of the seal during each stationary interval, allowing correlation with the traditional measurement of pavement surface texture and skid resistance. As the wheel 1 rotates along surface 3 each gyroscope reaches a stationary period in cycloid movement (as per the gyroscope numbered 2 in FIG. 2). At this point data from the gyroscope 2 may be utilised to determine surface movement as will be explained below. Either one, but usually two or more sets of wheels may be instrumented, including sensors on axles with single wheels and also on axles with dual wheel configuration, with readings taken usually in each wheel track but on some occasions the vehicle may be offset laterally so that readings can be taken between wheel tracks to compare parts of the road that have not been trafficked with other parts that have.

In an alternate embodiment shown in FIG. 2A a belt in the form of track 6 rotates about wheels 4 and 5. A number of gyroscopes 7 are provided at intervals along belt 6. As in the previous embodiment point data from each gyroscope 7 may be utilised to determine surface deflection when it is directly below one of the wheels.

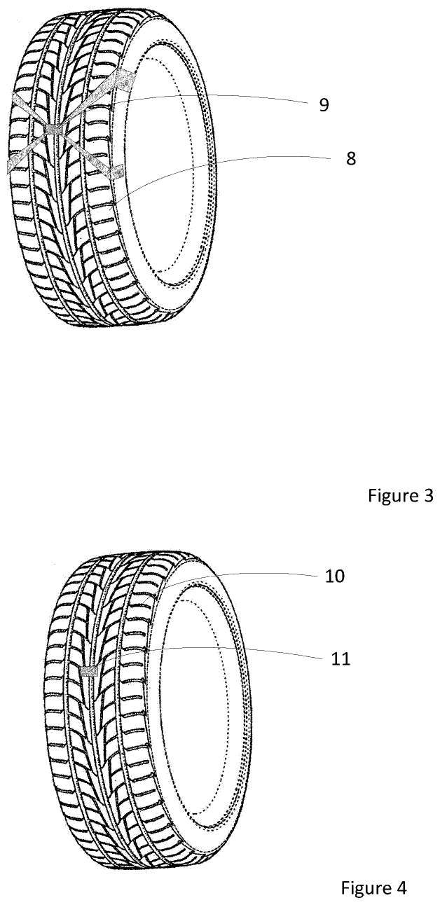

FIG. 3 shows a further embodiment in which one or more gyroscopes 9 may be provided on a mesh 8 fitted to a standard vehicle wheel. The mesh 8 may be of the type typically fitted to wheels to provide increased grip, such as snow chains. This approach has the advantage that a relatively inexpensive device may be fitted to a standard vehicle tyre to provide very useful measures of pavement deformation.

FIG. 4 shows a conventional tyre 10 having a gyroscope 11 embedded in the tread so that it is flush with the tyre tread.

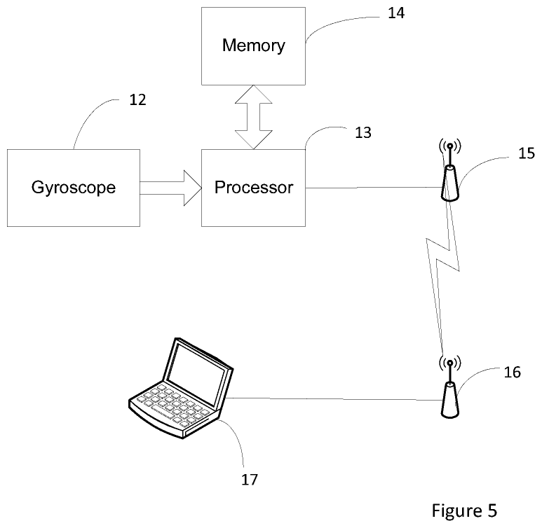

FIG. 5 shows a block diagram of a system for acquiring and processing information from a gyroscope. A ruggedised case may contain a gyroscope 12, processor 13, memory 14 and transmitter 15. Data from gyroscope 12 that is supplied to processor 13 may be stored in memory and/or transmitted via wireless transmitter 15. In a basic implementation transmitter 15 may be omitted and memory 14 may be a removable memory card that may be removed from the ruggedised casing after measuring and be inserted into a computer for processing. Where wireless transmitter 15 is employed memory 14 could be omitted with all data being transmitted to receiver 16 and stored by computer 17. Other communication channels such as wired or optical links may also be employed. Gyroscopes may typically be sampled at a rate of about 1-10 kHz.

Employing multiple gyroscopes to measure the pavement rotation under multiple different load configurations (narrow versus wide treads, single versus dual tyres, low versus high loads/horizontal speeds) may be used to provide test data which may be used with correlations to determine the various traditional parameters for structural design or asset management. Rotation measurements may be used to correlate against well recognised pavement structural design parameters such as curvature, standard curvature index under Falling Weight Deflectometer (FWD), deflection, or other offset parameters from the FWD, Benkelman Beam, Deflectograph, Rolling Wheel Deflectometer or Traffic Speed Deflectometer and similar traditional devices for measuring pavement structural capacity and remaining life. This allows generation of the critical strain parameters that can be applied to predict bearing capacity, rutting progression and roughness progression characteristics of pavements. This approach enhances the value of pavement testing while at the same time allowing for testing systems having fast moving wheel loads. The collected data can be used to determine vertical compressive strain, shear strain and horizontal tensile strain, which can be more valuable for the prediction of remaining life time and recommendations for repair and maintenance.

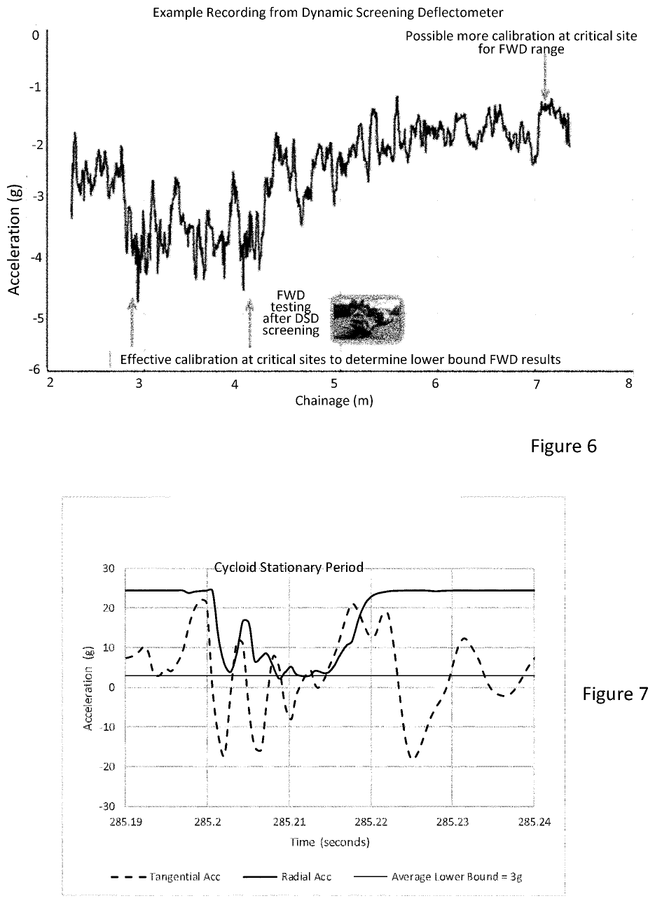

FIG. 6 shows a recording from an IMU embedded in a wheel of a fully loaded vehicle on a 5 km run with signal logged at 1 m intervals at an approximately constant speed of 70 km/hr. The interpretation may use data from the gyroscope alone or the accelerometer alone, as in most forms of pavement the acceleration and rotation signals form sub-parallel traces as they increase or decrease in sympathy. However increased accuracy is generally obtained by using the signals from both the gyroscope and accelerometer. The following comments for acceleration apply similarly for rotational measurements. The lower shaded zone (g<3.5) indicates pavement with strong accelerations and hence limited life. This information may be used directly or as the basis for directing traditional (FWD) tests to be performed. In this case FWD tests would be done just around the low points (here the 3 to 4 kilometre chainage), or for fuller calibration some would be done at the peaks, ie around chainage 7.0-7.2 km also.

Even if traditional FWD testing is performed in highlighted areas all necessary data may be collected for less than half the cost of using the traditional FWD device along the full length of the screening survey. In addition, there is a continuous output of structural condition at 1 metre intervals or more closely if desired which has the advantage of accurately determining the start and end of proposed rehabilitation sections or maintenance patches.

An important advantage of the present invention is that it can measure (at any speed) the pavement response at the point of maximum curvature in the centre of a continuously loaded area immediately beneath the load. None of the prior art devices for measurement of deformation at highway speed, does this. Other fast moving equipment (TSD and RWD) measure the movement between a pair of dual wheels, where there is locally no load on the pavement surface, so the deformation at the most heavily loaded point has to be inferred rather than measured.

In FIG. 7 carried out at high speed, the solid line depicts the acceleration in the radial direction versus time, while the dashed line depicts the acceleration in the circumferential direction, showing the noise that may develop from natural frequencies which affect the signal. In these cases, software is used to extract key elements of the system (e.g. solid line section) which are found by examination of both DSD and FWD records (or other traditional device) in the same interval of pavement, to be “signatures” characteristic of structural parameters. The interpretation becomes simpler when speed is reduced, but the signal may be filtered and averaged so that that reliable data can be collected at any speed, because the goal is to ensure the measuring equipment does not impede normal traffic flow (an increasing safety concern with FWD, Curviametre and Deflectograph). Software may be used to define the start and end of events (using both radial and circumferential axes of sensors). Software can also be used to help refine TSD deflection bowls because the velocity measured by the TSD immediately between the wheels is zero or very small, therefore it has low reliability. On the other hand, the rotational velocity at that point is large so the DSD results can be used to obtain more reliable estimates of the central part of the deflection bowl shape when it is integrated with TSD data.

Example Sequence of Implementation
1. Fix the gyroscope(s) securely inside a robust box (sensor housing).
2. Fix the sensor housing(s) at or near the perimeter of each wheel, in a manner that will allow the sensor housing to be flush with the tread around the wheel so that there will be no impact loading on the housing.
3. Load the axle(s) that incorporates the wheel(s) to the desired weight, being ideally the maximum axle loading planned for the pavement, with that tyre configuration and pressure.
4. Roll the wheel over a pressure pad to confirm the pressure on the housing is the same as the pressure on the surrounding tread (or record any difference).
5. Start the logger(s) to record at the appropriate frequency (commonly between 1 to 10 kHz). A micro-logger using a microSD card in or near the sensor housing may be adopted, or Bluetooth to a laptop computer in the vehicle if real-time monitoring is required.
6. Roll the wheel at creep speed (<1 km/hr) and carry out calibration checks.
7. Traverse the wheel at the required speed(s) over the test interval(s) required.
8. Repeat the creep speed calibration at the end of each traverse to confirm no shift in calibration.
9. Download the rotational velocity file, filter and report key parameters (such as standard curvature index) for each event.
10. Use the results to screen for areas of maximum deformation, (usually those that show greater than the 90 percentile value on each road are of particular concern as they govern the effective life of the pavement) and test these with traditional equipment (eg FWD or similar purpose device) for maximum accuracy, and use the rotational velocities to extrapolate or interpolate the localised FWD results to the full test interval.
   For some network surveys the screening survey may be used alone, where good historic correlations with FWD or similar devices are available.

Signal Processing

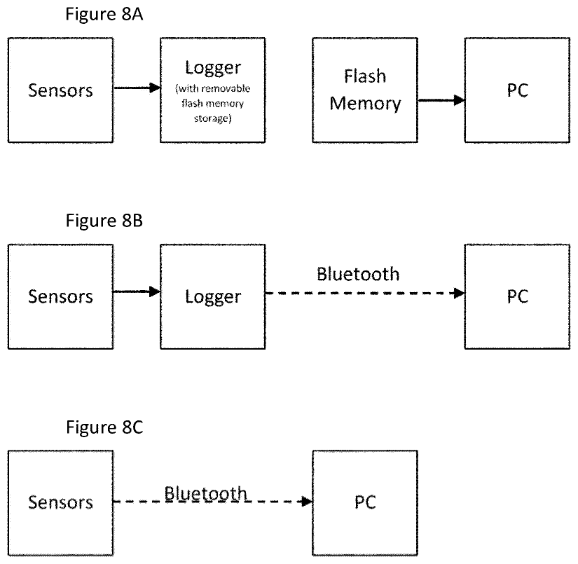

Data may be communicated from the sensor(s) to a processor, computing device or PC of any suitable kind by any suitable communications method, including one of those shown in FIGS. 8A to 8C.

In FIG. 8B, the logger carries out high frequency sampling (usually 1 to 10 kHz) of rotational velocities and forces, logging them to memory, and sending them via Bluetooth to a laptop computer. Once the raw data is available on the PC, the data is processed using software. The initial signal is filtered by picking “events” (stationary cycloid period). Data are stored for each event, including for representative intervals within each event, and for each axis, the angular velocity.

Rotational velocity measurements are used to correlate against well recognised pavement structural design parameters such as standard central deflection under Falling Weight Deflectometer (FWD), curvature function, surface curvature index, or other offset deflections and parameters from the FWD, Benkelman Beam, Deflectograph or Traffic Speed Deflectometer and similar traditional devices for measuring pavement structural capacity and remaining life.

For rapid turnaround of testing results, the median rotational velocity (vₘ) measured in units radians per second centred on the mid point of the cycloidal stationary period is related approximately to the widely used standard 40 kN Benkelman Beam deflection (d0) (or FWD central deflection) or, more directly to curvature (SCI). The relationships are given approximately by:

d0 (mm)=k1 vₘ and

SCI (mm)=k2 vₘ

Where SCI is the Surface Curvature Index (d0-d300) and k1 & k2 are constants for a given testing speed and loaded tyre size, (with the gyroscope placed centrally on the perimeter of a 35 kN large single tyre such as 385 65R 22.5 inflated to 700 kPa). It is relevant to this application that the magnitude of SCI is much smaller than d0, hence the signal to noise ratio makes accurate determination of SCI much more difficult for all prior art equipment because, until now, that equipment measures vertical movement. However, for reasons not yet understood, but presumably because rotation rather than vertical movement is the fundamental measure, the gyroscope signal has been found to be much less affected by the particular form of vibration generated by heavy vehicles including at speeds higher than 70 km/hr.

The advantage of this form of high level quantification at high speed and low cost is that a kilometre of pavement can be tested and reported in about 2 minutes, allowing immediate decisions on the structural capacity of the pavement.

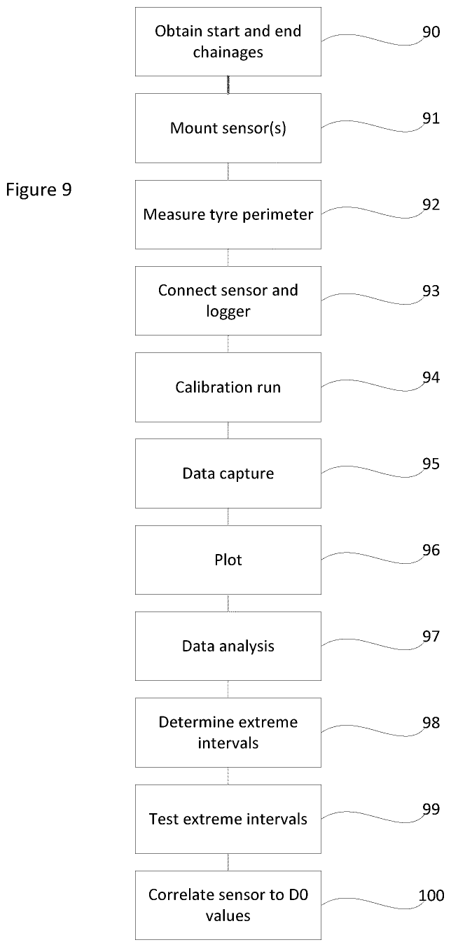

One embodiment of a measurement method will now be described with reference to FIG. 9.

At block 90, start and end changes for the road interval to be tested are obtained. These may be input manually by a user, or may be obtained automatically using a GPS device. In either case the start and end changes may be associated with GPS coordinates.

At block 91, one or more sensors are mounted at or near the perimeter of the tyre. The sensors may be mounted in any suitable rigid housing. The housings may be mounted in the tyre such that the rigid housing fits flush with the tyre surface and is firmly pressed against the road surface as the tyre rotates.

At block 92, the perimeter of the tyre is measured in its usual state of inflation. At block 93, the sensor is connected to a logger programmed for recording the rotational velocity. The sensor and logger may be arranged to record rotational velocity over a range of at least 0-100 degrees per second at 1-10 kHz sampling. Other forms of sensors may be used for refined readings.

At block 94, a calibration run is performed. The sensor and logger are actuated, such that rotational velocity data and concurrent GPS position data are captured. The testing vehicle is driven at creep speed (<1 km/hr). The captured data is assessed to check that the gyroscope does record smoothly as the sensor rotates around tyre.

At block 95 a data capture run is performed. The testing vehicle is run at typical but relatively constant speed for the road environment between the start and finish chainages.

At block 96 the rotational velocity may be plotted versus time and/or versus distance using the GPS information. Much of the plot may be in saturation for the sensor (i.e. the acceleration may be greater than the maximum measurable acceleration for the sensor), but in the relevant periods the rotational velocity will be between 2 and 20 degrees per second.

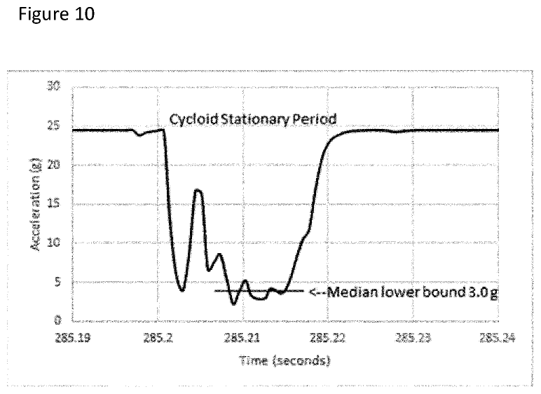

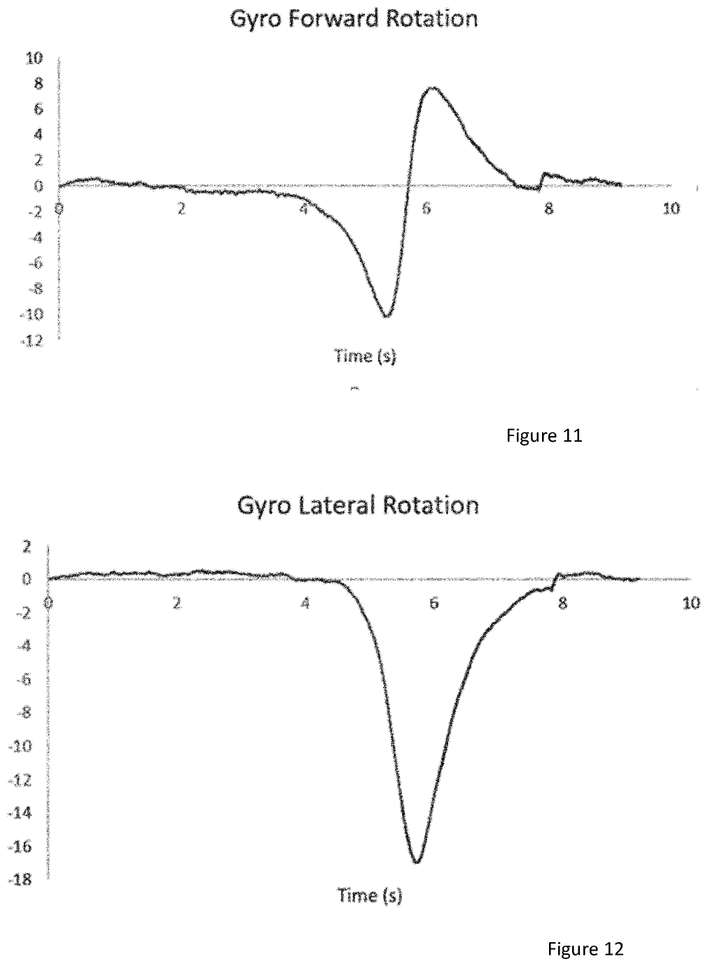

At block 97, stationary cycloid periods may be identified in the recorded data, smoothing vibrations or averaging over short lengths to identify the characteristic minimum rotational velocity period, in a similar fashion to that shown in FIG. 10, which shows an example plot of acceleration versus time, with both rotational velocity and accelerations exhibiting minima at about the same time. The minimum rotational velocity may be identified as a median lower bound for successive readings. The process may be performed graphically from time to time to ensure no anomalies are present, but conventional smoothing using software for filtering or determining running means may be used for production runs. When the rotational velocities are measured from an adjacent wheel or from a point on the surface within the deflection bowl, a typical set of forward and lateral gyro axes recorded at slow speed are shown in FIGS. 11 and 12. FIG. 15, displays the results (i.e. location and stiffness inferred from correlation with FWD, as well as other standard parameters calculated from the stiffness using any of the various pavement design manuals).

At block 98, by analysis of the characteristic rotational velocities versus distance, a number of positions on the road (preferably two or more) may be determined where extremes are evident. That is where the rotational velocities are smallest and greatest (usually those that are below the 10 percentile or above the 90 percentile of all readings for that road). These will reflect the stiffest and weakest intervals of pavement.

At block 99 the determined extreme intervals may be tested with any conventional pavement testing device to find the characteristic D0 and SCI values. For example, a Benkelman Beam, which records the transient surface deflection as a truck with dual wheels loaded to 40 kN travels over a given point, may be used. Alternatively, a Falling Weight Deflectometer which applies a load of about 40 kN to a 300 mm circular plate, or any other suitable device, may be used.

D0 is the central deflection and SCI is the curvature of the pavement under a 4.2 tonne (40 kN) dual wheel (or 300 mm load plate). Typical values of D0 are 0.3 mm for a heavy duty pavement, 0.9 mm for a moderately trafficked road or 1.5 mm for a lightly trafficked road. SCI, however, is much smaller; approximately 0.2 times D0. Other parameters which may be measured are the D0-D200 curvature index or the remaining life of the pavement, from standard correlations.

At block 100, the sensor may be correlated to the D0 or SCI values (or other preferred measure) for the road under consideration (checking for sensibility using data from previous projects). Typical values are about 2.5, 5 and 10 degrees per second for D0 values of 0.5, 1 and 1.5 mm when the testing speed is 50-70 km/hr, ie D0 (mm)=k* Rotational Velocity, where k is often about 0.2, and rotational velocity is in units of degrees per second. A more refined calibration should include speed.

Using the calibration, report the equivalent D0 deflection value versus chainage along the road. (And/or report the equivalent curvature and/or remaining life correlations and/or other parameter if preferred.)

Referring now to FIGS. 11 to 16 a methodology is described for processing the data from one or more gyroscope with one or more axis, to develop a profile of the stiffness of the layer or layers beneath the surface of a pavement during construction as each layer is applied or at the end of construction, with provision of software to enable immediate decisions. This allows simple and cost effective road construction and maintenance treatments such that a non-specialist user, such as a roading contractor, may be able to carry out testing and obtain most of the key information for pavement construction and maintenance decisions, including a rapid field test for determining if the compacted material is too wet, too dry or at optimum water content for compaction. Only time consuming laboratory tests provide such information currently. However, if the shape (smoothness) of the deformation curve (eg FIG. 12) is used, a smooth curve will be the result of a dry material beneath the surface whereas if the smoothness transforms to a more wavy curve (with the same overall trend) then that characteristic tends to reflect increasing water content. By correlating against the deformation shapes for layers which have been compacted for known different average water contents, the relative water content of any subsequent test can be quantified.

An exemplary process is:
(i) Locate contractor's truck front wheel on an earthfill layer just compacted or in a location where maintenance of a failing road surface is required.
(ii) Place on the surface about 1.5 m in front, and 0.2 m to one side of the front wheel, a sensing device, typically containing a set of 3 gyroscopes (or usually 3 IMUs each with 3 motion sensors (gyroscope, accelerometer and magnetic field) and 3 axes (giving a total of 27 traces recorded with one wheel pass).
(iii) Connect a smartphone or similar recorder by Bluetooth to the device, then drive forward until the rear (dual) wheels are about 1.5 m beyond the device. With two different wheel configurations (front single and dual rear) and hence different loaded areas, a total of 54 signal traces are recorded and analysed for each full test.

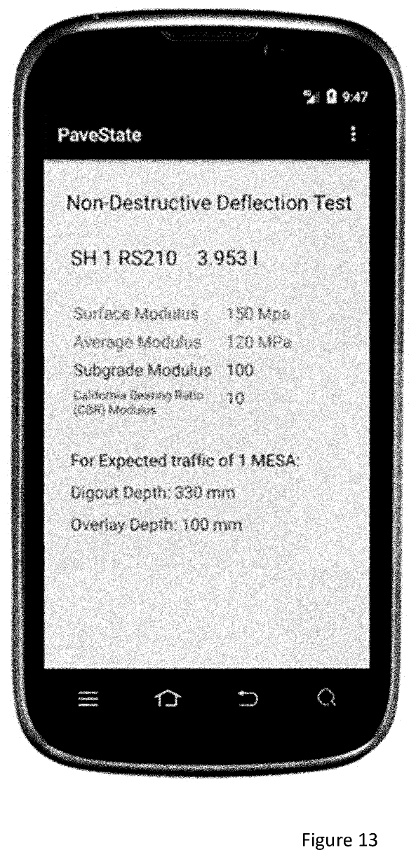

The smartphone can then immediately display both the results and interpretation of the test as shown in FIG. 13, together with necessary actions for quality control and maintenance.

Once calibrated against the “gold standard” for pavements (the FWD test using pavements in that region) the amplitude of the gyro pulse (See FIG. 12) quantifies both the stiffness of the pavement and the allowable traffic loading, while the relative width of the pulse correlates to how deep a failed section of pavement will need to be excavated and replaced with higher quality materials. The first is the key consideration in new pavement construction while both in combination provide the necessary parameters for maintenance (digouts or reconstruction). For maintenance, after the digout is backfilled, the situation is then effectively as for other new construction, ie the test should then be carried out again, to determine whether the patch is sufficiently compacted to have the surfacing layer applied, or is more compaction necessary. The new device and methodology thus address and effectively preclude the commonly encountered issue that a significant proportion of digouts undergo premature failure, often within a year, usually because the necessary depth of excavation is not accurately defined.

The principal information for new construction is the uniformity and stiffness of the underlying material including whether compaction requirements have been met for fill and what additional thickness of confining layers are necessary to carry specific highway traffic. For maintenance of existing pavement, output is whether only the surfacing requires sealing or if deeper layers require improvement or replacement and if so how deep. A smartphone can be preloaded with the necessary correlations with FWD or TSD data for any particular region. Using an internet connection, much more detailed design information can be accessed by searching a national database containing several million FWD structural analyses, to generate many other parameters including the inferred pavement profile of stiffness versus depth (layer moduli and subgrade stiffness, i.e. California Bearing Ratio). As well as providing quantitative design parameters and quality assurance immediately and without the need to call on others, even if customary equipment and personnel were available, the cost is almost two orders of magnitude less than would result from traditional providers.

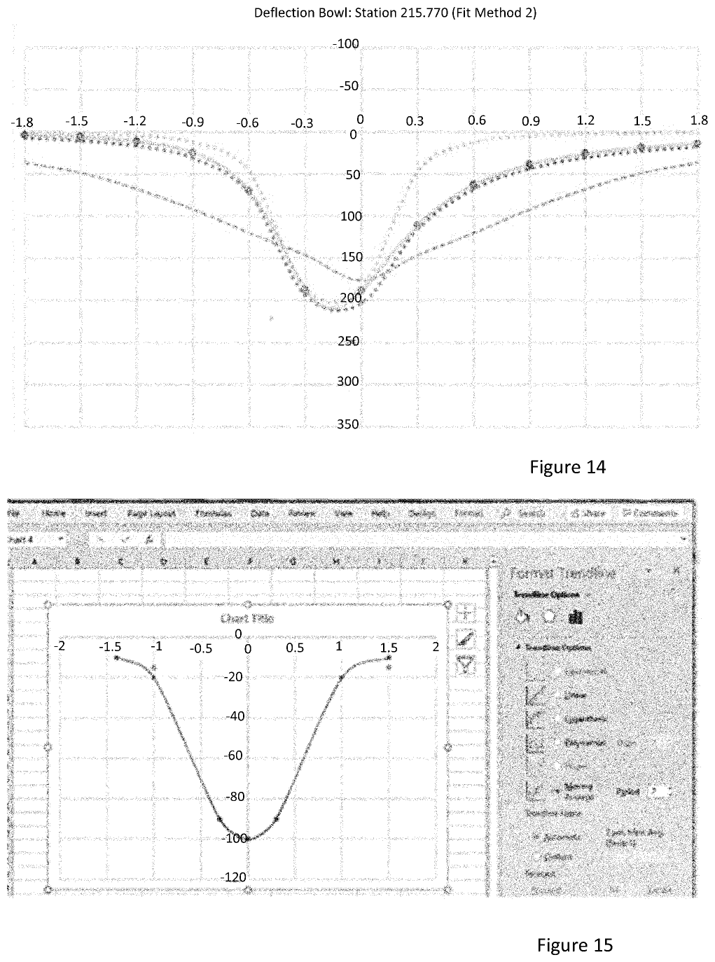

The exemplary description below illustrates how the sample data shown in FIG. 14 may be interpreted. The x axis shows the distance in metres from the centre of the loaded wheel, and the y value shows the deflection in microns of the pavement due to compression of the layers beneath from the load. First, any standard double integration is done to convert the rotations to deflections, then any of the traditional curve fitting solutions available from recognised software packages (such as Excel in the example shown in FIG. 15) are used to join the individual points into a full deflection bowl.

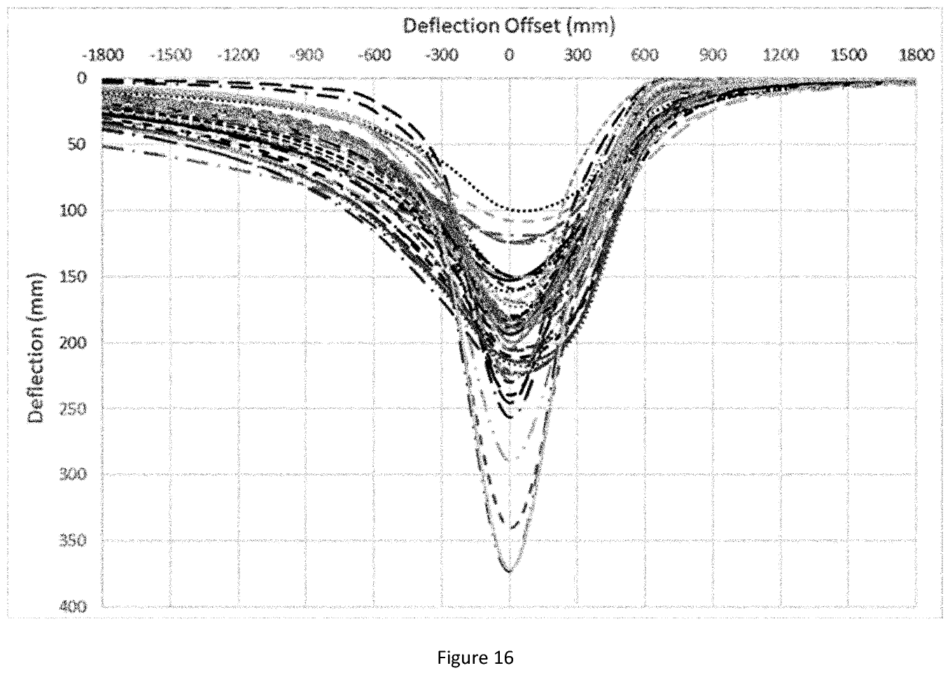

By adjusting for a range of assumptions for drift and curve fitting methods a variety of bowls such as those above are generated (see FIG. 16), all being apparently valid solutions. To decide which is the optimum solution, deflection bowls from a database from that locality, as measured by widely recognised devices such as TSD or FWD, are then used to see which are the closest fits.

Once the optimum bowl fit is made (depending upon the optimisation parameter(s)), the parameters for that bowl as recorded in the database are assigned to that location. When that is done with an internet connection, the user may immediately view the parameters relevant to the situation, including for instance for existing pavements: remaining life for given traffic intensity, required overlay thickness or depth of digout for repair, stiffness (moduli) change with depth; and for earthfill construction: traditional compaction parameters (moduli and relation to optimum water content) and thickness of overlying layers to provide adequate structural capacity. The immediate access to this information without needing specialist equipment or lengthy laboratory testing is the principal benefit of the procedure.

By using different wheel configurations (diameter, width, material hardness, inflation pressure, single versus dual wheels) the loaded area is changed, and the different motions from variously located sensors on the tread then allow back analysis of the likely pavement structure. This is a result of the inevitable load spreading effect of pavement layers which results in the ratio of strains in the upper layer to the strains in the subgrade increasing as the loaded area is concentrated to a smaller footprint, while applying the same total load.

The basic bowl parameters derived from multiple gyroscopes enable conventional multi-layer elastic theory (used as the basis for FWD interpretation) to be used for back-analysis. Explanations of both empirical and analytical methods of analysing FWD deflections are detailed widely, including in the following link: http://www.pavementinteractive.org/article/deflection-based-nondestructive-pavement-analyses/

Other systematic interpretation comprises methodical determination of characteristic signatures from individual forms of pavement with known profiles and layer properties, using repeated observations, preferably using FWD measurements on the same intervals of pavement for correlation with the most accurate form of testing currently available A largely observational approach can also be used, by testing an interval of pavement that has experienced known intensity of traffic, but exhibits varying severity of distress (from incipient to terminal). The observational method is then used to assign the limiting rotational velocities that relate to each incremental level of distress severity. (Signatures from other parameters after integration or differentiation with respect time) can all show varying degrees of correlation with structural distress, depending on the composition of the various pavement layers.)

No other device known to the Applicant uses the stationary cycloid period for measuring rotational velocity at or near the most pertinent point of maximum loading (immediately beneath a tyre contact area), and is capable of measuring rotations effectively over such a wide range of vehicle speeds. The method and system is simple and convenient, allowing measurements to be performed at normal driving speeds and having much lower capital and operating costs than all other traditional devices. The data obtained may also be quickly analysed and available to users within a few minutes of testing, much sooner than any other high speed device, (for which customary delivery times are many weeks). This is because a large amount of test data can be generated, that relates simply to the most widely recognised test concepts in pavement engineering (standard deflection and curvature under a 40 kN wheel load).

While the stationary cycloid principle may be used alone, it offers major increases in sensitivity to Doppler layer TSD operation also because these lasers use measurement of pavement velocity away from the centre of the loaded wheels, because velocity is essentially zero at the mid point of the deflection bowl. However, pavement curvature values are at their peak beneath the centre of the load and are comparatively huge as that is clearly the point that the load finishes its loading phase and initiates its unloading phase. Therefore, the signal to noise ratio is high and it provides a key data point on the pavement deformation bowl that is omitted with traditional TSD devices at present. The result of the combination is more accurate definition of the entire bowl. Other major advantages in combining the invention with TSD technology is that it will extend the TSD capability to both higher or lower speeds than its currently limited range, enable testing in wet conditions as well as dry, on unsurfaced roads as well as sealed, on corners as well as straights. All of the latter are limitations with existing highway speed devices (TSD and RWD).

The method described allows short-period, high frequency measurement during the stationary cycloid period experienced by a rolling weight or wheel moving at traffic speed by a device located on or in proximity to the perimeter of the wheel for the purposes of evaluating one or more engineering properties of the pavement (not properties related to the tyre or wheel). The engineering properties are (i) the curvature of the pavement deflection bowl using primarily a gyroscope or less direct measure such as a strain gauge to measure bending or inertial forces during the stationary cycloid period; (ii) the texture of the surface using a fluid under measured pressure or less direct measure.

The systems and methods described above allows:
1. Large volumes of data to be processed
2. A mechanistic analysis of the stresses and strains of each reading at as small an interval as desired.
3. Automatic quality assurance of the data.
4. Automatic derivation of calibration for an entire network, determining all distress modes for the pavements
5. Mechanistic determination of remaining life and rehabilitation requirements
6. Structural Maintenance (digout and, patching). The timing and nature of the maintenance required on the network, identifying to a resolution of 2 metres or less, the extents and form of required maintenance, the year in which that will be required, and cost.

The system and method mechanistically determines in a methodical fashion the reason(s) that a pavement will become terminal (fail structurally), and it does this from any well populated pavement management database, by automatically finding the critical stresses and strains that have resulted in the past for each distress mode then applying these to a pavement deterioration model to generate programmes for (i) future structural maintenance and (ii) future structural rehabilitation. The programmes have a far higher level of reliability and predict far further ahead (many years) than any existing techniques for assessing future budget requirements.

As well as in combination with Doppler lasers, the invention may also be used in combination with other developing technologies that use either distance or velocity measurements including RWD and stereo imaging. When dual wheels are instrumented and used in combination with a conventional Benkelman Beam the comparison enables a very simple calibration and assurance test that is widely recognised and understood throughout the industry.

Embodiments of the invention are described herein with reference to schematic view illustrations. As such, the actual dimensions of the elements of the present invention may vary depending on the particular arrangement of the invention as well as the manufacturing techniques employed. Embodiments of the invention should not be construed as limited to the particular shapes or sizes of the elements illustrated herein but are to include deviations. Thus, the elements illustrated in the figures are schematic in nature and their shapes are not intended to illustrate the precise shape of an element and are not intended to limit the scope of the invention. The present invention is described herein with reference to certain embodiments, but it is understood that the invention can be embodied in many different forms and should not be construed as limited to the embodiments set forth herein. In particular many different sensor and wheel load arrangements can be provided beyond those described above, and many different sensors, sensor housings, loads, pressures can be used depending on whether the purpose is for construction quality assurance, pavement life determination, asset management or rehabilitation design. The texture of the pavement also affects the form of housing for the sensor (steel, plastic etc) and degree of calibration for each operating speed. Many alterations and modifications may be made by those having ordinary skill in the art, given the benefit of the present disclosure, without departing from the spirit and scope of the inventive subject matter. Therefore, it must be understood that the illustrated embodiments have been set forth only for the purposes of example, and that it should not be taken as limiting the inventive subject matter as defined by the following claims. Therefore, the spirit and scope of the invention should not be limited to the versions described above.

1. A method of measuring deformation or structural properties of a surface or its underlying layers comprising:
i. providing a gyroscope positioned to measure deformation at or near the periphery of a rolling weight;
ii. rolling the rolling weight over the surface;
iii. analysing one or more signals developed by the gyroscope during a stationary cycloidal period of the gyroscope; and
iv. developing a measure of surface deformation or structural properties based on the one or more signals.

2. A method as claimed in claim 1 wherein the rolling weight is travelling at a speed above about 20 kmph

3. A method of measuring deformation or structural properties of a surface or its underlying layers comprising:
i. providing an IMU positioned to measure deformation at or near the periphery of a rolling weight;
ii. rolling the rolling weight over the surface;
iii. analysing one or more signals developed by the IMU at or near a stationary cycloidal period of the IMU; and
iv. developing a measure of surface deformation or structural properties based on the one or more signals.

4. A method as claimed in claim 3 wherein the IMU includes one or more accelerometer and one or more gyroscope.

5. A method as claimed in claim 4 wherein the IMU includes three gyroscopes and/or accelerometers with their axes of measurement orthogonal to one another.

6. A method as claimed in claim 4 wherein the IMU includes three gyroscopes with their axes of measurement orthogonal to one another.

7. A method as claimed in claim 4 wherein the IMU includes one or more magnetometers.

8. A method as claimed in claim 1 wherein the rolling weight is a loaded wheel.

9. A method as claimed in claim 8 wherein a plurality of wheels are employed.

10. A method as claimed in claim 9 wherein two or more wheels are offset and each include a gyroscope at or near the periphery of each wheel.

11. A method as claimed in claim 9 including a loaded wheel and an adjacent measuring wheel or other rotating body having a lesser loading and being offset from the loaded wheel and having a gyroscope at or near its periphery.

12. A method as claimed in claim 1 including a plurality of wheels in which different wheel configurations are employed in terms of one or more of: wheel tracking, wheel offset, wheel loading, wheel stiffness and wheel tyre pressure.

13. A method as claimed in claim 1 wherein each gyroscope includes a transmitter for transmitting information from each gyroscope or IMU that is mounted on the rolling weight away from the periphery of the rolling weight.

14. A method as claimed in claim 1 wherein analysing one or more signals developed by the gyroscope and developing a measure of surface deformation or structural properties of the underlying layers includes:
i. integrating rotational data from the gyroscope to obtain deflection data;
ii. applying a curve fitting solution to the deflection data;
iii. generating a plurality of potentially valid solutions based on different assumptions; and
iv. selecting a solution based on comparison with a reference deflection bowl or from a spectrum of bowls in a database assembled from earlier field measurements or theory.

15. A method as claimed in claim 14 wherein the assumptions include one or more of: drift and curve fitting solution.

16. A method as claimed in claim 1 wherein the gyroscope is positioned in or on the surface and the rolling weight is rolled over the surface near the gyroscope.

17. A method as claimed in claim 16 wherein an amplitude of pulse output by the gyroscope is used to provide a measure of the stiffness of the pavement or allowable traffic loading.

18. A method as claimed in claim 16 wherein a pulse shape output by the gyroscope is used to provide a measure of the stiffness of the pavement or allowable traffic loading.

19. A method as claimed in claim 16 wherein the width of a pulse output by the gyroscope is used to indicate a depth of a failed section of pavement.

20. A method as claimed in claim 16 wherein a pulse shape output by the gyroscope is used to indicate a depth of a failed section of pavement.

21. A method of determining water content of material underlying a surface by measuring deformation of the surface at or near a rolling weight and determining water content of the underlying material based on the relative smoothness of the shape of the response curve compared with a reference curve of a surface having known water content.
